(19) United States
(12) Patent Application Publication
(10) Pub. No.: US 2004/0025699 A1
(43) Pub. Date: Feb. 12, 2004

(54) Beverage infusion package with improved freshness and reduced dusting

(76) Inventors: Stephen Wintersgill, Rochadale (GB); John Robinson, Rochdale (GB)

Correspondence Address: Woodard Emhardt Moriarty, McNett & Henry, Suite 3700, 111 Monument Circle, Indianapolis, IN, 46204, US

(21) Appl. No.: 10/398,685

(22) PCT Filed: Oct. 8, 2001
(86) PCT No.: PCT/GB01/04452

(30) Foreign Application Priority Data
Oct. 9, 2000 (GB) 0024665.2

(51) Int. Cl. A23L 1/00

(52) U.S. Cl. 99/275

(57) ABSTRACT

A beverage infusion package comprises a bag, made form a porous, fibrous tissue, containing a beverage perecursor material wherein said tissue material has been treated, by a metered dosing process, with a flavor retaining polysaccharide or modified polysaccharide. Also a tissue material suitable for use in making such a package.

The present invention relates to a beverage infusion package (e.g. Tea bags, coffee bags and the like), but may also find application in other forms of packaging containing materials which are prone to degradation (particularly in response to exposure to air) and are to be infused with water whilst remaining, wholly or partially, within the package. The invention also relates to the porous, fibrous web materials used in the construction of such packages and a method of treatment therefore.

Beverage infusion packages, such as tea or coffee bags, comprise a particulate beverage precursor material, such as tea leaves, coffee grinds, spray dried flavour enhancers etc., in a bag, pouch, sachet or the like (henceforth, for reasons of convenience, generically referred to as bags) comprising a porous, fibrous material. The material is generally cellulosic in nature having typical basis weights of between 10 to 30 grammes per square metre (gsm). Again, for reasons of convenience, these bag materials shall be referred to as tissue. The tissue used in bag making may be either a heat sealable or a non-heat sealable tissue, the heat sealable tissue typically comprising a layer rich in polypropylene fibres to facilitate heat sealing.

To produce a beverage, the bag is infused with hot water. This infusion may be performed by, for example, immersing the bag in hot water, pouring hot water over the bag, percolating hot water through the bag or heating the bag, whilst submersed in water, in a microwave (or conventional) oven.

The bag of the present invention may be a “one cup” style bag, containing sufficient beverage precursor material for a single brew, however, the invention is equally applicable to multi-brew bags, such as those commonly used in catering establishments, in coffee machines.

A disadvantage of such packages is that, unless special precautions are taken, there may be degradation of the beverage precursor material, particularly caused by oxidation or loss of volatile components of flavour, during storage. In order to obviate this degradation, manufacturers tend to utilise high performance external packaging, such as sealed foil wrappers, which may be flushed with an inert gas or alternatively vacuum packed, which is very effective as an oxygen purgative or oxygen barrier, and drastically reduces the aforementioned degradation. However, if a multi-pack of catering style bags is opened, when the first bag is used the remaining bags start immediately to degrade, meaning that only the first bag used is delivering a true flavour.

Coffee suffers particularly from this degradation of flavour, with a large proportion of the subtler overtones of flavour being both extremely volatile and also very prone to chemical attack by oxidising materials (such as molecular, atmospheric oxygen). Therefore, when exposed to atmospheric conditions, fresh ground coffee very rapidly loses the higher notes of its flavour, a problem which is exacerbated by the fact that ground coffee has a large surface area to volume ratio.

A further problem with current beverage infusion packages is the loss of small dry particles of beverage precursor material through the porous tissue leading to loss of contents which in turn leaves deposits on the inside of any outer packaging, this problem is widely recognised within the industry and henceforth will be referred to as dusting. Currently there are two methods of counteracting dusting, both of which have their own disadvantages. Firstly, a higher grade of tea, comprising larger particles, can be used, however, higher grades of tea are more expensive and in shorter supply than the more powdery, lower grades of tea. Alternatively, the perforations in the bag may be reduced in size (or a less porous tissue used to make the bag) meaning smaller particles are trapped, however, this reduces the rate of infusion of the beverage when the bag is immersed in hot water, this is seen as highly undesirable.

Several attempts have been made to overcome these problems; the most pertinent to the present invention is outlined below.

U.S. Pat. No. 5,243,164 (ERICKSON) describes partitioning a coffee filter paper and a measured dose of coffee from a reservoir of water, using a water soluble/dispersible film. However, ERICKSON is directed toward a microwave device and the system used in U.S. Pat. No. 5,243,164 is dependent upon the partition being maintained under tension, and it is this tension, in conjunction with the change in material properties of the partition material on exposure to hot water, which enables ERICKSON's device to operate. However, it is clear that a standard beverage infusion package is not generally maintained in such a state of tension, for instance whilst someone is preparing a pot of tea.

For reasons of clarity, the term “printing” will be used in a generic sense, and as such should be taken to include both printing, coating and similar processes.

It is an object of the present invention to increase the “fresh-life” of a beverage infusion package, after its outer packaging has been removed, whilst reducing the level of dusting observed and not adversely affecting the flavour of the beverage produced.

According to a first aspect of the present invention, there is provided a beverage infusion package comprising a bag, made from a porous, fibrous tissue, containing a beverage precursor material, wherein said tissue material has been treated, by a metered dosing process, with one or more cyclodextrin compounds.

The treatment of the tissue with the cyclodextrin may take place at various different stages of the manufacturing process, for example, during preparation of the pulp(s), during size pressing, during re-humidification or may be performed as a post production operation, such as a printing operation.

The treatment of the tissue with the cyclodextrin may be such that a physical bond is formed between tissue and cyclodextrin, however, it is preferably such that a covalent, chemical bond is formed between the modified anhydroglucose groups and the cellulosic fibres of the tissue (such treatment methods are known for cotton fibres in textiles etc.).

The cyclodextrin may comprise an α- and/or β- and/or χ-cyclodextrin, the selection of an individual cyclodextrin or a blend of cyclodextrins being largely dependent on the nature of the odour and/or flavour molecules that are present. For reasons of clarity, the term cyclodextrin shall be used to refer to any of the cyclodextrins named and blends thereof.

The cyclodextrin may comprise a native cyclodextrin and/or a modified cyclodextrin.

The modification is preferably a monochlorotriazenyl—(MCT) modification of the hydroxyl groups on the substituent anhydroglucose units, from which the cyclodextrin is formed.

The degree of substitution, per anhydroglucose is preferably between 0 and 1, more preferably between 0.3 and 0.5.

The cyclodextrin is preferably applied at levels of 0-10% w/w with respect to the basis weight of the tissue, more preferably 0-7% and most preferably 0-5%.

The tissue preferably has a basis weight in the range of 1 to 50 gsm, more preferably 5 to 40 gsm and more preferably 10 to 30 gsm.

The beverage infusion package may further be treated with a water soluble, film forming polysaccharide, preferably comprises a non-toxic, food approved substance.

The water soluble, film forming polysaccharide may comprise a starch, a dextrin or a combination of starches and dextrins.

The film forming polysaccharide is preferably laid down at a weight of 1 to 30 gsm, more preferably 1 to 20 gsm and more preferably 5 to 15 gsm.

The film formed is preferably from 1 to 30 microns in thickness, more preferably 1 to 20 microns and more preferably 5 to 15 microns.

The metered dosing process preferably comprises a printing process.

The film forming polysaccharide may be applied in such a manner that it is ultimately either inside or outside the beverage infusion package, alternatively a layer of coating or print may be applied to both sides of the web.

The metered dosing process may alternatively comprise addition of the film forming compound at the size pressing stage of the papermaking process.

The film forming polysaccharide is preferably external of the cyclodextrin, thereby physically delaying egress of volatile flavour components, allowing more time for them to become entrapped within cyclodextrin cavities.

According to a second aspect of the present invention, there is provided a material for use in forming the bag of a beverage infusion package, said material comprising a porous, fibrous tissue which has been treated, by a metered dosing process, with one or more cyclodextrin compounds.

The treatment of the tissue with the cyclodextrin may take place at various different stages of the manufacturing process, for example, during preparation of the pulp(s), during size pressing, during re-humidification or may be performed as a post production operation, such as a printing operation.

The treatment of the tissue with the cyclodextrin may be such that a physical bond is formed between tissue and cyclodextrin, however, it is preferably such that a covalent, chemical bond is formed between the modified anhydroglucose groups and the cellulosic fibres of the tissue (such treatment methods are known for cotton fibres in textiles etc.).

The cyclodextrin may comprise an α- and/or β- and/or χ-cyclodextrin, the selection of an individual cyclodextrin or a blend of cyclodextrins being largely dependent on the nature of the odour and/or flavour molecules that are present. For reasons of clarity, the term cyclodextrin shall be used to refer to any of the cyclodextrins named and blends thereof.

The cyclodextrin may comprise a native cyclodextrin and/or a modified cyclodextrin.

The modification is preferably a monochlorotriazenyl—(MCT) modification of the hydroxyl groups on the substituent anhydroglucose units, from which the cyclodextrin is formed.

The degree of substitution, per anhydroglucose is preferably between 0 and 1, more preferably between 0.3 and 0.5.

The cyclodextrin is preferably applied at levels of 0-10% w/w with respect to the basis weight of the tissue, more preferably 0-7% and most preferably 0-5%.

The tissue preferably has a basis weight in the range of 1 to 50 gsm, more preferably 5 to 40 gsm and more preferably 10 to 30 gsm.

The beverage infusion package may further be treated with a water soluble, film forming polysaccharide, preferably comprises a non-toxic, food approved substance.

The water soluble, film forming polysaccharide may comprise a starch, a dextrin or a combination of starches and dextrins.

The film forming polysaccharide is preferably laid down at a weight of 1 to 30 gsm, more preferably 1 to 20 gsm and more preferably 5 to 15 gsm.

The film formed is preferably from 1 to 30 microns in thickness, more preferably 1 to 20 microns and more preferably 5 to 15 microns.

The metered dosing process preferably comprises a printing process.

The film forming polysaccharide may be applied in such a manner that it is ultimately either inside or outside the beverage infusion package, alternatively a layer of coating or print may be applied to both sides of the web.

The metered dosing process may alternatively comprise addition of the film forming compound at the size pressing stage of the papermaking process.

The film forming polysaccharide is preferably external of the cyclodextrin, thereby physically delaying egress of volatile flavour components, allowing more time for them to become entrapped within cyclodextrin cavities.

The film forming polysaccharide, or more accurately the film formed thereby, reduces degradation of the beverage precursor material by reducing the permeability (to air) of the beverage infusion package. However, due to the water soluble nature of the material, when the bag is immersed in water, the infusion is able to brew normally as the film is rapidly dissolved.

Furthermore, the film serves to reduce dusting by providing a continuous layer over the surface area of the tissue, providing a physical barrier to beverage precursor material, thereby preventing its escape from the bag, when the film dissolves, water infuses in and swells the particles of beverage precursor material, thereby preventing any further loss. This means that smaller particles of beverage precursor material can be used, representing a cost saving to the tea packer and/or a more porous bag material can be used, providing better and quicker brewing characteristics.

In the case of coffee bags, a further advantage is obtained. When coffee begins to oxidise carbon dioxide is produced. In bags according to the present invention, even if the film is slightly air permeable, this results in a positive internal pressure, reducing further the rate of diffusion of air into the bag, thus further prolonging the life span of the beverage precursor material.

The cyclodextrin entrains evaporating flavour and/or odour molecules, protecting them from oxidative damage and releasing them upon immersion in hot water, thereby providing a fresher tasting and/or smelling beverage.

According to a first embodiment, the tissue is treated by running the web through a solution of MCT-β-cyclodextrin (CAVASOL®W7 MCT, ex Wacker-Chemie), followed by squeezing between two nip rollers, drying, heating and rinsing (for a complete method, see “Textile Finishing With MCT-β-Cyclodextrin”—J. P. Moldenhauer, H. Reuscher, Wacker-Chemie GmbH, or “Beta W7 MCT—New Ways In Surface Modification”—H. Reuscher and R. Hirsenkorn, Wacker-Chemie GmbH) leaving from 5-10% w/w MCT-β-cyclodextrin covalently bound to the tissue.

The tissue is then used to make coffee bags, being first treated by passing through hot water and drying to remove any inclusion complexes from the cyclodextrin cavities, with the coffee being ground immediately prior to encasement within the tissue material, such that escaping volatile flavour components are trapped within the cyclodextrin cavities—a process which continues after the coffee bags are foil wrapped, only ceasing when all of the cyclodextrin cavities are occupied. Upon use to brew a beverage, the coffee bag is saturated with hot (near boiling) water, which flushes the volatile flavour components out of the cavities, leaving them dispersed, on a molecular level, within the beverage, thereby providing a cup of coffee with an extra fresh taste.

In a second embodiment, the tissue is treated with MCT-β-cyclodextrin, as described in the previous embodiment, and then treated with a 30% w/w solution of Crystal Tex 627™, ex National Starch (a water soluble, film forming dextrin). The dextrin treatment comprises three passes, of the web, through a flexographic printing press, with a blank print cylinder (i.e. Set up to run as a coating press, giving 100% coverage), using the Crystal Tex 627™ solution as an “ink”. The web was dried in between coatings and both passes applied the dextrin to the same surface (ultimately the inside surface), thereby reducing the probability of obtaining an incomplete film. After treatment, the tissue was used to form heat sealed beverage pouches in the standard manner, the film having no detrimental effect on the heat sealability of the material. Samples of the material were then tested for air permeability. Three different tissue materials were used in the trials, a heat sealable, 25 gsm coffee pouch material (481704 ex J. R. Crompton), a heat sealable, 16.5 gsm teabag material (482906 ex J. R. Crompton) and a non-heat sealable, 12.5 gsm teabag material (488002 ex J. R. Crompton), the reductions in air permeability are given in table 1.

TABLE 1
Air Permeability Measurements.

| | | | | Air |
|---|---|---|---|---|
| | Number of | Basis Weight | Coating | Permeability |
| Material | Passes | g/m² | Weight (g/m²) | m³/min/m² |
| 481,704 | 0 | 25.87 | 0 | 42 |
| | 1 | | 2.07 | 28 |
| | 2 | | 3.96 | 26 |
| | 3 | | 6.64 | 20 |
| 482,906 | 0 | 16.64 | 0 | 110 |
| | 1 | | 2.46 | 102 |
| | 2 | | 4.51 | 61 |
| | 3 | | 7.56 | 55 |
| 488,002 | 0 | 12.37 | 0 | 93 |
| | 1 | | 2.35 | 63 |
| | 2 | | 5.24 | 57 |
| | 3 | | 7.08 | 49 |

Air permeability measurements were taken as the volume of air flow per square metre of tissue, with a 1.27 cm water gauge pressure drop, per minute.

It is clear that substantial reductions in air permeability were achieved in each case, with the relative porosities being reduced by approximately 50% for each type of tissue. Beverage pouches prepared using the above tissue samples were used in the preparation of beverages and no detrimental effect to their brewing characteristics was observed. The coatings did not adversely affect the flavour or appearance of the beverage.

The cyclodextrin cavities can be flushed, although this must be done prior to coating with Crystal Tex 627™, to avoid removal of the coating. Alternatively, the MCT-β-cyclodextrin treatment can be followed by the Crystal Tex 627™ printing process(es) providing a complete tissue product, the cyclodextrin cavities then being flushed immediately prior to use, by stripping with dry nitrogen at elevated temperature. The tissue is then used to form beverage pouches in the standard manner.

For convenience the preceding description has dealt exclusively with beverage infusion packages, however, it will be readily appreciated by one skilled in the art that the present invention may be equally applied to other packages having a porous outer bag and a content which is prone to degradation and requires treatment with water whilst remaining inside the package, similarly the specific materials disclosed in the two embodiments are given by way of example only and are not meant to be restrictive, as one skilled in the art would quickly recognise many other suitable materials. Therefore, it should be recognised that the description and incorporated embodiments are in no way intended to limit the scope of the invention, which is defined in the attached claims.

1. A method for producing a beverage infusion package comprising a bag, made from a porous, fibrous tissue, containing a beverage precursor material, characterised in that the method comprises the steps of treating said tissue material by a metered dosing process with one or more flavour retaining cyclodextrin compounds, removing inclusion complexes from cavities in the cyclodextrin compounds by flushing before forming the tissue into said bag.

2. A method according to claim 1, wherein the treatment causes formation of covalent bonds between the cyclodextrin(s) and the tissue fibres.

3. A method according to either of claims 1 or 2, wherein said one or more cyclodextrin compounds comprise at least monochlorotriazenyl-β-cyclodextrin.

4. A method according to any preceding claim, wherein the at least one cyclodextrin compound is applied at levels of 0-10% w/w with respect to the basis weight of the tissue.

5. A method according to any preceding claim, wherein the infusion package is further treated with a water soluble, film forming polysaccharide.

6. A method according to claim 5, wherein said film forming polysaccharide comprises one or more compounds selected from the group comprising starches, modified starches and dextrins.

7. A method according to any preceding claim, wherein said metered dosing process is a printing or coating process.

8. A method according to any of claims 1 to 6, wherein said metered dosing process forms a part of the paper manufacturing process.

9. A method according to any preceding claim, wherein said beverage precursor is selected from the group comprising tea, coffee and derivatives thereof.

10. A method for forming porous, fibrous tissue material, suitable for making beverage infusion packages, characterised in that the method comprises the steps of treating said tissue material by a metered dosing process, with one or more cyclodextrin flavour retaining compounds and removing any inclusion complexes from cavities in the cyclodextrin compounds by flushing.

11. A method according to claim 10, wherein the treatment causes formation of covalent bonds between the cyclodextrin(s) and the tissue fibres.

12. A method according to either of claims 10 or 11, wherein said one or more cyclodextrin compounds comprise at least monochlorotriazenyl-β-cyclodextrin.

13. A method according to any of claims 10 to 12, wherein the at least one cyclodextrin compound is applied at levels of 0-10% w/w with respect to the basis weight of the tissue.

14. A method according to any of claims 10 to 13, wherein the tissue material is further treated with a water soluble, film forming polysaccharide.

15. A method according to claim 14, wherein said film forming polysaccharide comprises one or more compounds selected from the group comprising starches, modified starches and dextrins.

16. A method according to any of claims 10 to 15, wherein said metered dosing process is a printing or coating process.

17. A method according to any of claims 10 to 15, wherein said metered dosing process forms a part of the paper manufacturing process.
